(19) United States
(12) Patent Application Publication
(10) Pub. No.: US 2015/0253921 A1
(43) Pub. Date: Sep. 10, 2015

(54) Scanning Method for Touch Panel

(71) Applicant: AU Optronics Corp., Hsin-Chu (TW)

(72) Inventors: Ren-Jie Pan, Hsin-Chu (TW); Sin-Guo Jhou, Hsin-Chu (TW); Sheng-Yun Chang, Hsin-Chu (TW); Keng-Han Chuang, Hsin-Chu (TW); Yu-Min Hsu, Hsinchu County (TW)

(21) Appl. No.: 14/617,948

(22) Filed: Feb. 10, 2015

(30) Foreign Application Priority Data
Mar. 5, 2014 (TW) 103107505

(51) Int. Cl. G06F 3/041; G06F 3/044

(52) U.S. Cl. CPC G06F 3/0416; G06F 3/044; G06F 2203/04112; G06F 2203/04104

(57) ABSTRACT

A touch panel scanning method includes transmitting a first driving signal into a first signal line of a side of a touch panel in a power saving mode; receiving a first sensing signal from a second signal line of the side of the touch panel; and determining if the first sensing signal satisfying a predetermined rule so as to control the touch panel to perform a corresponding operation; wherein the first sensing signal relates to a mutual capacitance between the first signal line and the second signal line.

### BACKGROUND OF THE DISCLOSURE

1. Field of the Disclosure

The present application relates to a scanning method for touch panel, and more particularly, a scanning method in a power-saving mode for touch panel.

2. Technical Background

Touch panels can reduce necessary hardware and space for input/output (I/O) devices, and allow users to interact with electronic devices more intuitively and conveniently, therefore touch panels have been widely used in electronic devices such as smart phones, laptop computers and tablet computers. For users' expectation for longer standby time, a portable devices such as a smart phone or a tablet computer is expected to have good power saving performance. A touch panel can be set into an operational mode or a power-saving mode according to the prior art so as to decrease power consumption. In the operational mode, a touch panel should be able to detect accurate touch control and display with high luminance; and in a power-saving mode (e.g. a sleep mode) triggered by staying idle for a predetermined idle period or a manual control, the touch panel stands by with low power consumption without entering the operational mode until a touch event occurs, that is, the touch panel receives a touch control.

To keep a touch panel able to detect the occurrence of touch event, a touch panel keeps executing scanning and reading rather than being completely turned off in a power-saving mode. FIG. 1 illustrates driving signal lines 1101 to 110m and sensing signal lines 1201 to 120n of a touch panel 100 in a power-saving mode according to the prior art. In the power-saving mode, driving signals D1 to Dm are sent through the driving signal lines 1101 to 110m respectively from top to bottom sequentially to perform scanning, and a system receives sensing signals S1 to Sn through the sensing signal lines 1201 to 120n respectively to perform reading. For example, when a touch event occurs at the intersection of the driving signal line 1105 and the sensing signal line 1029 in the power-saving mode, after the driving signal D5 is sent, the voltage value of the sensing signal S9 is correspondingly changed due to the change of the inductive capacitance caused by the touch event at the intersection, the system is able to detect the occurrence of the touch event by detecting the change of the sensing signal S9 with considering the time of sending the driving signal D5 and then wakes up the touch panel 100 accordingly to set the touch panel 100 in the operational mode. The location of a touch event can be accurately located in the power-saving mode by means of the aforementioned prior art, but the effect of power saving is not ideal because the scanning needs to be performed for a large number of sensing signals to be received for checking all intersections. Taking the touch panel 100 in FIG. 1 for example, when the touch panel 100 is in the power-saving mode without being awakened, the driving signals D1 to Dm should be sent sequentially in a frame period, and the sensing signals S1 to Sn should be received in the frame period, therefore (m×n) times of reading of scans are performed to check if any touch event occurs around the (m×n) intersections. Since all the (m×n) intersections are checked in each frame period, sending and reading so many driving signals and sensing signals in each frame period lead the power consumption in the power-saving mode not to be reduced well.

### SUMMARY OF THE DISCLOSURE

An embodiment of the present application discloses a touch panel scanning method, comprising sending a first driving signal via a first signal line of a first side of a touch panel when the touch panel is in a power-saving mode; receiving a first sensing signal via a second signal line of the first side of the touch panel when sending the first driving signal; and controlling the touch panel to execute an corresponding action according to whether the first sensing signal complies with a predetermined rule; wherein the first sensing signal is related to an inductive capacitor between the first signal line and the second signal line.

Another embodiment of the present application discloses a touch panel scanning method, comprising sending a set of driving signals via a first set of signal lines of a first side of a touch panel when the touch panel is in a power-saving mode; receiving a set of sensing signals via a second set of signal lines of the first side of the touch panel when sending the set of driving signals; and controlling the touch panel to execute a corresponding action according to whether the set of sensing signals complies with a predetermined rule; wherein the set of sensing signals is related to a set of inductive capacitors between the first set of signal lines and the second set of signal lines.

These and other objectives of the present application will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates driving signal lines and sensing signal lines of a touch panel in a power-saving mode according to the prior art.

FIG. 2 illustrates a touch panel according to an embodiment of the present disclosure.

FIG. 3 illustrates an equivalent RC circuit of the touch panel of FIG. 2 in a power-saving mode without occurring any touch event according to an embodiment of the present disclosure.

FIG. 4 illustrates an equivalent RC circuit of the touch panel of FIG. 2 in a power-saving mode when occurring a touch event according to an embodiment of the present disclosure.

FIG. 5 illustrates the sending of driving signals and the receiving of sensing signals of a touch panel according to the first embodiment of the present disclosure.

FIG. 6 illustrates a flow chart of a scanning method according to the first embodiment of the present disclosure.

FIG. 7 illustrates the sending of driving signals and the receiving of sensing signals on a touch panel according to the second embodiment of the present disclosure.

FIG. 8 illustrates a flow chart of a scanning method according to the second embodiment of the present disclosure.

FIG. 9 illustrates the sending of driving signals and the receiving of sensing signals of a touch panel according to the third embodiment of the present disclosure.

FIG. 10 illustrates a flow chart of a scanning method according to the second embodiment of the present disclosure.

### DETAILED DESCRIPTION

FIG. 2 illustrates a touch panel 200 according to an embodiment of the present disclosure. The touch panel 200 includes m signal lines 2101 to 210m, each having their own signal line capacitance. For example, the signal line 201x has a signal line capacitance Cₓ and a signal line resistance Rₓ, the signal line 201x+1 has a signal line capacitance C_{x+1,} a signal line mutual capacitance Cₘ exists between the signal lines 201x and 201x+1, and a capacitance C_{d-s} generated between two adjacent signal lines exists between the signal line 201x and a signal line 220y of two different directions.

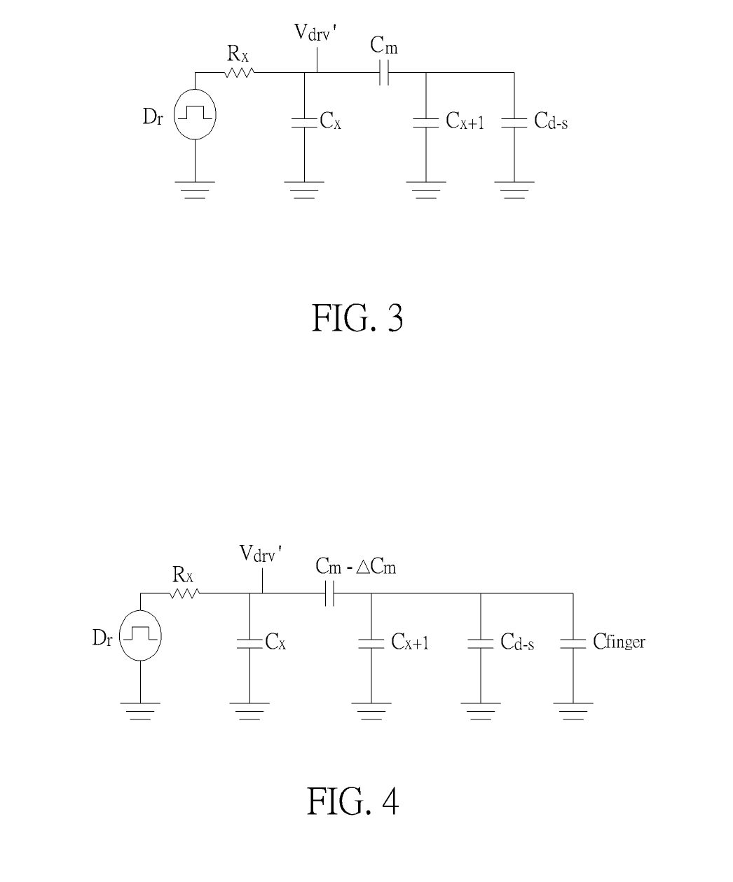

FIG. 3 illustrates an equivalent RC circuit of the touch panel 200 in a power-saving mode without occurring any touch event according to an embodiment of the present disclosure. FIG. 4 illustrates an equivalent RC circuit of the touch panel 200 in a power-saving mode when occurring a touch event according to an embodiment of the present disclosure. According to FIG. 3, when the touch panel 200 is in the power-saving mode without occurring any touch events, a driving voltage source Dr sends a driving signal with a driving voltage value V_{drv}′ a corresponding sensing signal is received through the signal line 201x+1, and the sensing signal has an untouched voltage value V_{no-touch} which may be calculated with the following equation (a).

V_{no-touch}=V_{drv}′×Cₘ/(Cₘ+Cₓ₊₁+C_{d-s}) (a)

According to FIG. 4, when a touch event occurs on the touch panel 200 in the power-saving mode, taking a finger touching the touch panel 200 for example, the finger may have a finger parasitic capacitance C_{finger} and the sensing signal on at the signal line 210x+1 may have a touched voltage value V_{touch} which may be calculated with the following equation (b).

V_{touch}=V_{drv}′×(Cₘ−ΔCₘ)/(Cₓ₊₁+Cₘ−ΔCₘ+C_{finger}+C_{d-s}) (b)

The variation ΔCₘ is a variation of the signal line mutual capacitance Cₘ after the touch event occurs. By comparing FIGS. 3 and 4, a variation of the mutual capacitance between signal lines is generated after a touch event such as a finger or a stylus touching the touch panel 200. According to the equation (b), when the variation of a mutual capacitance is greater than a predetermined value, and a finger parasitic capacitance on a finger makes a sensing signal have the touched voltage value V_{touch}, a touch event is accordingly determined.

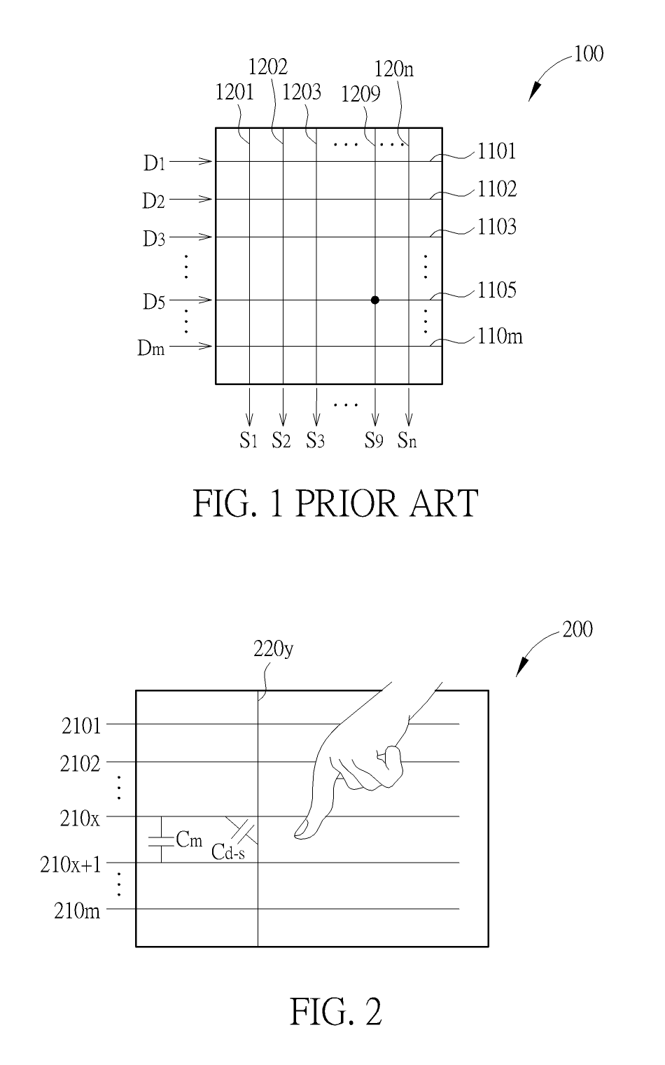

According to mentioned equations (a) and (b), when a driving signal is sent through a signal line, if a touch event triggered by a finger or a stylus, the voltage value of a sensing signal sensed from adjacent signal lines may vary accordingly so that a touch event on a touch panel in a power-saving mode can be detected. Different from the touch panel 100 of the prior art shown in FIG. 1, for the touch panel 200 shown in FIG. 2, although the sensing signals are also received after the driving signals are sent so as to determine if any touch event occurs in the power-saving mode, the sending of the driving signal and the receiving of the sensing signal are in the same dimension (e.g. in the horizontal direction, sending and receiving of signals at the left side) on the touch panel 200 instead of being in two different dimensions such as sending the driving signals at the left side (in the horizontal direction) and receiving the sensing signals at the bottom side (in the vertical direction). The horizontal and the vertical directions are allowed to be defined according to application.

### The First Embodiment

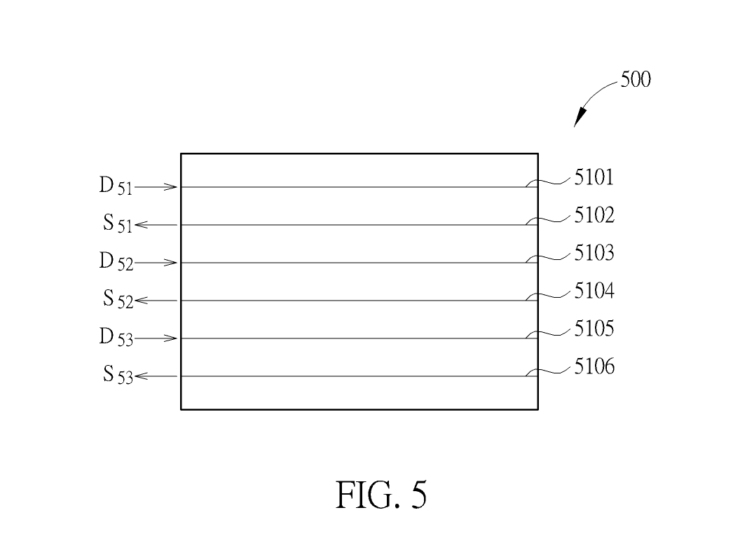

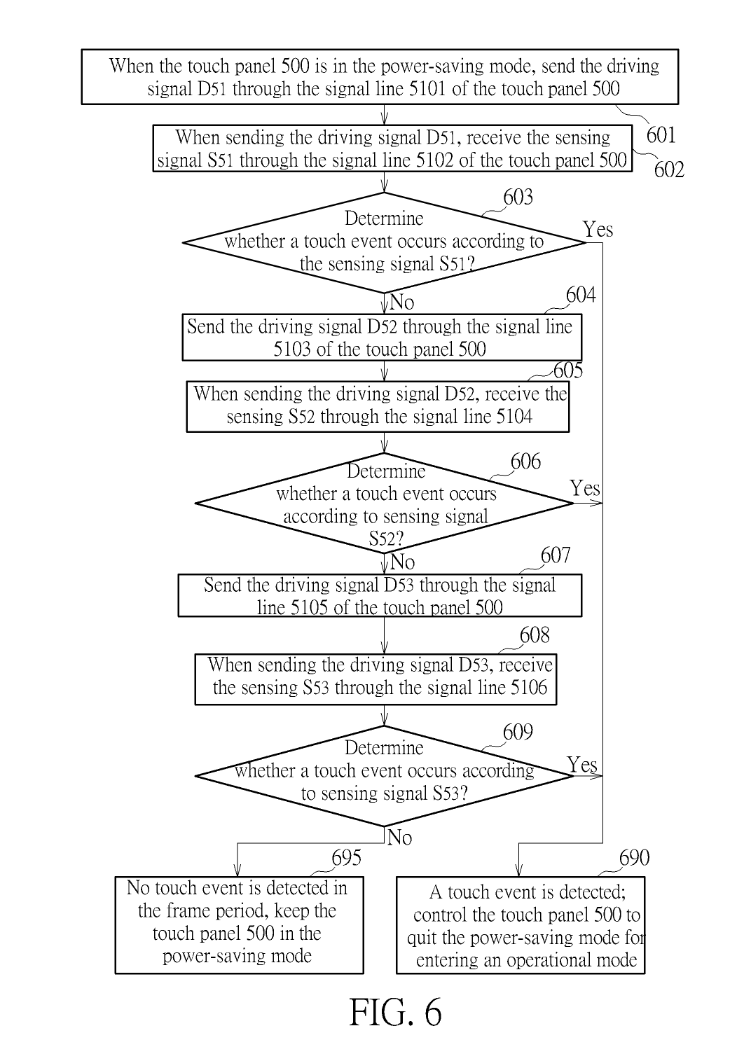

FIG. 5 illustrates the sending of driving signals and the receiving of sensing signals of a touch panel 500 according to the first embodiment of the present disclosure. According to FIG. 5, the driving signals may be sent, and the sensing signals may be received both at the left side (or the right side) of the touch panel 500 through the six signal lines 5101 to 5106. In the touch panel 500, the sending of the driving signals and the receiving of the sensing signals are both at (but not limited to) the left side. The sending of the driving signals and the receiving of the sensing signals should be at the same side according to the first embodiment of the present disclosure. FIG. 6 illustrates a flow chart of a scanning method according to the first embodiment of the present disclosure. The scanning method includes the following steps:

Step 601: When the touch panel 500 is in the power-saving mode, send the driving signal D51 through the signal line 5101 of the touch panel 500;

Step 602: When sending the driving signal D51, receive the sensing signal S51 through the signal line 5102 of the touch panel 500;

Step 603: Determine whether a touch event occurs according to the sensing signal S51? If yes, enter step 690; if no, enter step 604;

Step 604: Send the driving signal D52 through the signal line 5103 of the touch panel 500;

Step 605: When sending the driving signal D52, receive the sensing S52 through the signal line 5104;

Step 606: Determine whether a touch event occurs according to sensing signal S52? If yes, enter step 690; if no, enter step 607;

Step 607: Send the driving signal D53 through the signal line 5105 of the touch panel 500;

Step 608: When sending the driving signal D53, receive the sensing S53 through the signal line 5106;

Step 609: Determine whether a touch event occurs according to sensing signal S53? If yes, enter step 690; if no, enter step 695;

Step 690: A touch event is detected; control the touch panel 500 to quit the power-saving mode for entering an operational mode;

Step 695: No touch event is detected in the frame period, keep the touch panel 500 in the power-saving mode.

According to the first embodiment of the present disclosure, the determination of the occurrence of the touch event in steps 603, 606 and 609 is performed according to the method explained in FIGS. 2 to 4 described above, that is to detect whether a touch event occurs around the signal lines through which the driving signals are sent according to the variation of the sensing signals. The touch panel 500 shown in FIG. 5 has only six signal lines, but the number of signal lines is not limited to six according to the embodiment of the present disclosure. In the scanning method disclosed by the first embodiment, the driving signals are sent through the odd number of signal lines sequentially from top to bottom, and the sensing signals are received through the even number of the signal lines. Hence, when the number of the signal line of the horizontal direction is m, the number of times of the receiving of the sensing signal is only m/2. For example, there are six signal lines in the touch panel 500 of FIG. 5, so it is necessary to receive the sensing signals three times. Therefore, it requires only m/2 times of reading of scans to detect whether a touch event occurs in one frame period. The signal lines of another direction (e.g. the vertical direction) is unnecessary to be considered. Comparing with the method related to the touch panel 100 of the prior art shown in FIG. 1, the number of the driving signal lines of the touch panel 100 of the horizontal direction is also m, but the n sensing signal lines of the vertical direction should be considered in order to perform m×n times of reading of scans for detecting touch events. Hence, the number of times of the reading of scans may be reduced to be merely (m/2)/(m×n) times, that is (½n) times, of the prior art by using the method according to the first embodiment of the present disclosure.

### The Second Embodiment

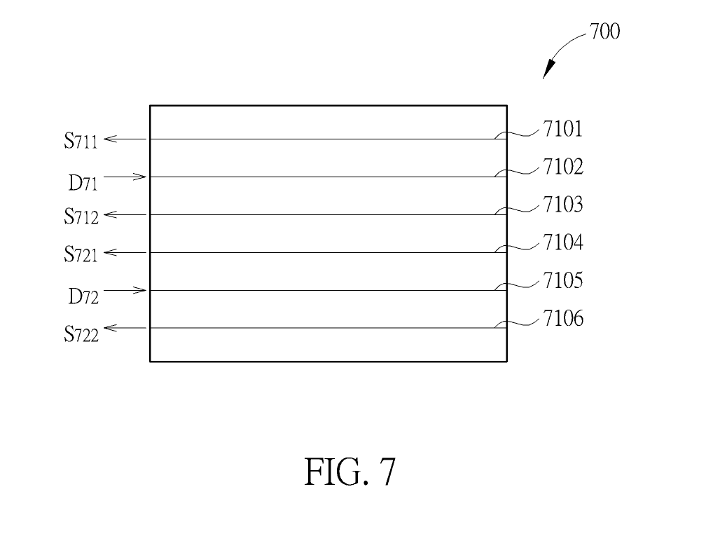

FIG. 7 illustrates the sending of driving signals and the receiving of sensing signals in a touch panel 700 according to the second embodiment of the present disclosure. According to FIG. 7, the driving signals may be sent, and the sensing signals may be received at the left side (or the right side) of the touch panel 700 through the six signal lines 7101 to 7106. In the touch panel 700, the sending of the driving signals and the receiving of the sensing signals are both at (but not limited to) the left side. The sending of the driving signals and the receiving of the sensing signals should be at the same side according to the second embodiment of the present disclosure.

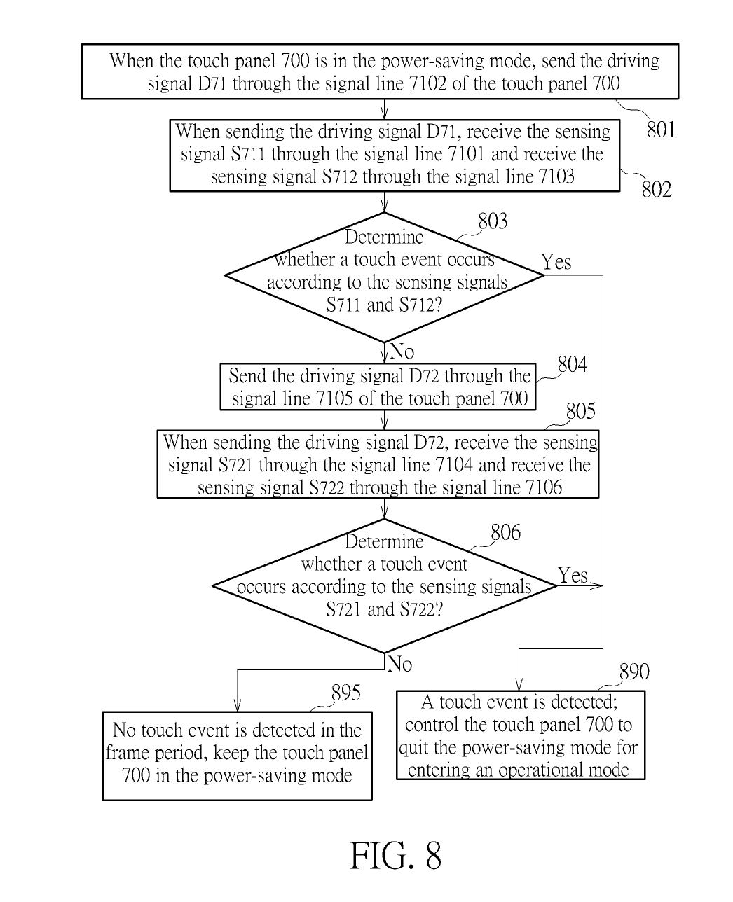

FIG. 8 illustrates a flow chart of a scanning method according to the second embodiment of the present disclosure. The scanning method includes the following steps:

Step 801: When the touch panel 700 is in the power-saving mode, send the driving signal D71 through the signal line 7102 of the touch panel 700;

Step 802: When sending the driving signal D71, receive the sensing signal S711 through the signal line 7101 and receive the sensing signal S712 through the signal line 7103;

Step 803: Determine whether a touch event occurs according to the sensing signals S711 and S712? If yes, enter step 890; if no, enter step 804;

Step 804: Send the driving signal D72 through the signal line 7105 of the touch panel 700;

Step 805: When sending the driving signal D72, receive the sensing signal S721 through the signal line 7104 and receive the sensing signal S722 through the signal line 7106;

Step 806: Determine whether a touch event occurs according to the sensing signals S721 and S722? If yes, enter step 890; if no, enter step 895;

Step 890: A touch event is detected; control the touch panel 700 to quit the power-saving mode for entering an operational mode;

Step 895: No touch event is detected in the frame period, keep the touch panel 700 in the power-saving mode.

According to the embodiment of the present disclosure, the determination of the occurrence of the touch event in steps 803 and 806 is performed according to the method described in FIGS. 2 to 4 above, that is to detect whether a touch event occurs around the signal lines through which the driving signals are sent according to the variation of the sensing signals. The touch panel 700 shown in FIG. 7 has only six signal lines, but the number of signal lines is not limited to six according to the embodiment of the present disclosure. In the scanning method disclosed by the second embodiment of the present disclosure, the signal lines are grouped into a plurality of groups each having three signal lines from the top to the bottom, a driving signal is sent through the second signal line of the three signal lines of a group, then two sensing signals are received through the first and the third signal lines of the group so as to determine whether a touch event occurs by detecting if the sensing signals change corresponding to the change of an inductive capacitance caused by a touch event. When a touch event occurs, the inductive capacitance between the first and the second signal lines and the inductive capacitance between the second and the third signal lines changes accordingly so as to make the sensing signals change, and the touch event can be detected. Hence, when there are m signal lines in the horizontal direction, the number of times of receiving the sensing signals would be only (m/3). Taking the touch panel 700 having six signal lines for example, the number of times of receiving the sensing signals is 6/3, that is two. This means that only (m/3) times of reading of scans is required to determine whether a touch event occurs in one frame period in the power-saving mode. Moreover, the signal lines of another direction such as the vertical direction are not necessary to be concerned. However, when using the method of the touch panel 100 of the prior art, (m×n) times of reading of scans are required. Hence, comparing with method of the prior art described in FIG. 1, the required number of times of reading of scans may be reduced to (m/3)/(m×n) times, that is (⅓n) times, by using the method according to the second embodiment of the present disclosure.

According to another embodiment, it is allowed to group the signal lines into multiple groups each having multiple signal lines, the driving signals are sent through each of the signal lines of a group in a specific sequence, and the other signal lines of the group (except for the signal line used to send the driving signal) are used to receive the sensing signals corresponding to the inductive capacitances and the change of the inductive capacitances among the mentioned signal line for sending the driving signal and the other signal lines for receiving the sensing signals. Please refer to the following third embodiment.

### The Third Embodiment

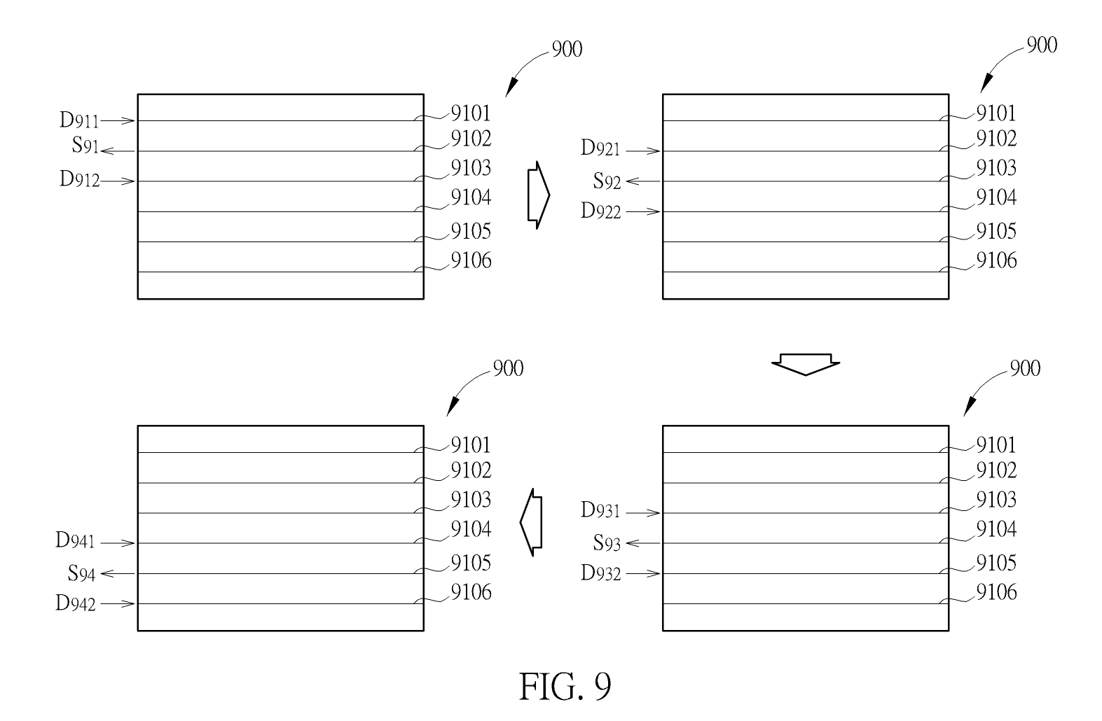

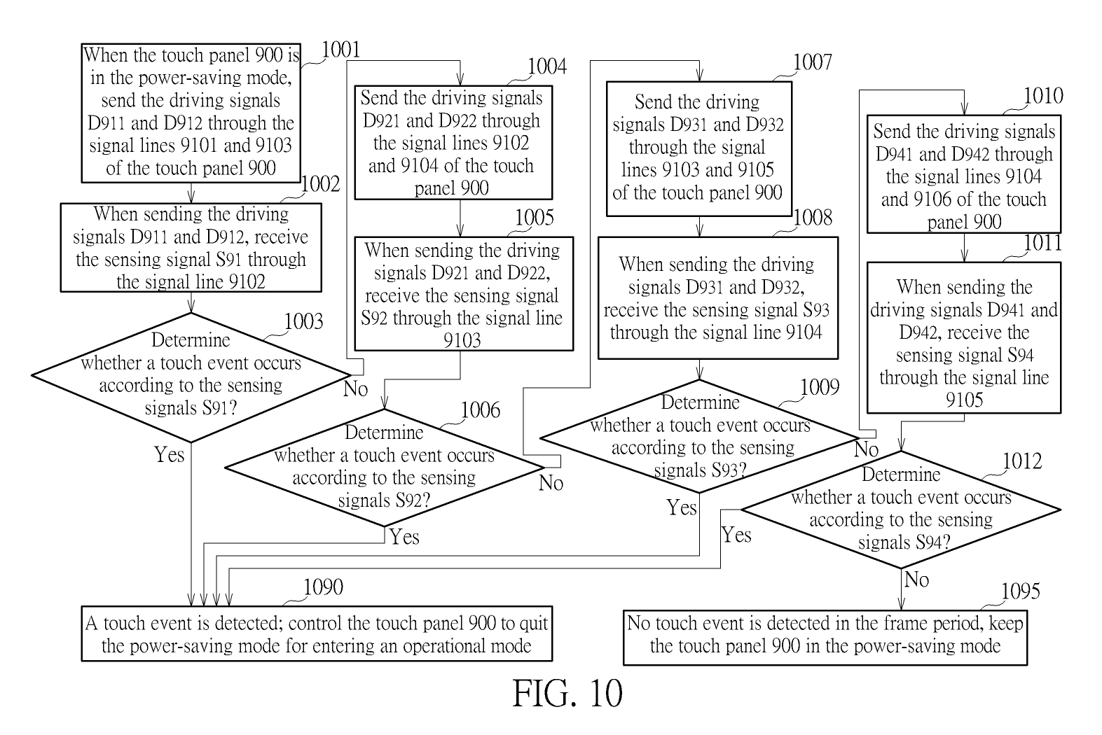

FIG. 9 illustrates the sending of driving signals and the receiving of sensing signals in a touch panel 900 according to the third embodiment of the present disclosure. According to FIG. 9, the driving signals may be sent, and the sensing signals may be received at the left side (or the right side) of the touch panel 900 through the six signal lines 9101 to 9106. In the touch panel 900, the sending of the driving signals and the receiving of the sensing signals are both at (but not limited to) the left side. The sending of the driving signals and the receiving of the sensing signals should be at the same side according to the third embodiment of the present disclosure.

FIG. 10 illustrates a flow chart of a scanning method according to the third embodiment of the present disclosure. The scanning method includes the following steps:

Step 1001: When the touch panel 900 is in the power-saving mode, send the driving signals D911 and D912 through the signal lines 9101 and 9103 of the touch panel 900;

Step 1002: When sending the driving signals D911 and D912, receive the sensing signal S91 through the signal line 9102;

Step 1003: Determine whether a touch event occurs according to the sensing signals S91? If yes, enter step 1090; if no, enter step 1004;

Step 1004: Send the driving signals D921 and D922 through the signal lines 9102 and 9104 of the touch panel 900;

Step 1005: When sending the driving signals D921 and D922, receive the sensing signal S92 through the signal line 9103;

Step 1006: Determine whether a touch event occurs according to the sensing signals S92? If yes, enter step 1090; if no, enter step 1007;

Step 1007: Send the driving signals D931 and D932 through the signal lines 9103 and 9105 of the touch panel 900;

Step 1008: When sending the driving signals D931 and D932, receive the sensing signal S93 through the signal line 9104;

Step 1009: Determine whether a touch event occurs according to the sensing signals S93? If yes, enter step 1090; if no, enter step 1010;

Step 1010: Send the driving signals D941 and D942 through the signal lines 9104 and 9106 of the touch panel 900;

Step 1011: When sending the driving signals D941 and D942, receive the sensing signal S94 through the signal line 9105;

Step 1012: Determine whether a touch event occurs according to the sensing signals S94? If yes, enter step 1090; if no, enter step 1095;

Step 1090: A touch event is detected; control the touch panel 900 to quit the power-saving mode for entering an operational mode;

Step 1095: No touch event is detected in the frame period, keep the touch panel 900 in the power-saving mode.

According to the embodiment of the present disclosure, the determination of the occurrence of the touch event in steps 1003, 1006, 1009 and 1012 is performed according to the method described in FIGS. 2 to 4 above, that is to detect whether a touch event occurs around the signal lines through which the driving signals are sent according to the variation of the sensing signals. The touch panel 900 shown in FIG. 9 has only six signal lines, but the number of signal lines is not limited to six according to the embodiment of the present disclosure. In the scanning method disclosed by the third embodiment of the present disclosure, the signal lines are grouped into a plurality of groups each having three signal lines from the top to the bottom, two driving signals are sent through the first and third signal lines of the three signal lines of a group, and a sensing signal is received through the second signal line of the group so as to determine whether a touch event occurs by detecting if the sensing signal changes corresponding to the change of an inductive capacitance caused by a touch event. According to FIG. 9, the first two signal lines (e.g. the signal lines 9102 and 9103) of the three signal lines (e.g. the signal lines 9102, 9103 and 9104) of a group are the last two signal lines (e.g. the signal lines 9102 and 9103) of the three signal lines (e.g. the signal lines 9101, 9102 and 9103) of the previous group. Hence, when there are m signal lines in the horizontal direction, the number of times of receiving the sensing signals would be only (m−2). Taking the touch panel 900 having six signal lines for example, the number of times of receiving the sensing signals is (6−2), that is four. This means that merely (m−2) times of reading of scans is required to determine whether a touch event occurs in one frame period in the power-saving mode without considering the signal lines of another direction (e.g. the vertical direction). When m is a larger number such as 200 or a number greater than 1000, (m−2) may be close to m, so the required number of reading of scans may be seen as m. Comparing with the method disclosed in FIG. 1 which requires (m×n) times of reading of scans, the required number of times of reading of scans may be reduced to (m)/(m×n) times, that is (1/n) times, by using the method disclosed by the third embodiment of the present disclosure.

### CONCLUSION

Taking a touch panel with m signal lines in the horizontal direction, n signal lines in the vertical direction and (m×n) intersections for example, when using the scanning method in the power-saving mode according to an embodiment of the present disclosure, a touch event may be merely located at the signal lines through which the driving signals are sent rather than being located at an accurate intersection of the (m×n) intersections, because the (m×n) intersections are not checked one by one sequentially in the method disclosed by the present disclosure. This is the trade-off of the method disclosed by the present disclosure. However, when in the power-saving mode, the detection of a touch event is only for the touch panel to be awakened to quit the power-saving mode and enter the operational mode when a touch event occurs, so it is unnecessary to locate a touch event accurately.

In summary, when a touch panel has m signal lines in the horizontal direction and n signal lines in the vertical direction, by using the scanning method for the touch panel in the power-saving mode disclosed by the present disclosure, the number of times of reading of scans (i.e. the times of receiving the sensing signals) can be reduced to (½n), (⅓n) or (1/n) times if comparing with the required number of times of reading of scans according to the method of the prior art. For example, when n is 200, the required number of times of reading of scans may be 1/400, 1/600 or 1/200 times the required number of times of reading of scans in the prior art. Because only one side instead of two sides of signal lines are used to send or receive signals in the power-saving mode, power consumption may be therefore reduced around 50%, and the required time and the power consumption for scanning and sending/receiving signals may be further greatly reduced for the required number of times of reading of scans is greatly decreased (e.g. merely 1/600 times of the prior art). Hence, the scanning time and the power consumption for detecting whether any touch event occurs in the power-saving mode may be reduced considerably by using the scanning method for the touch panel in the power-saving mode according to the embodiment of the present disclosure.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A touch panel scanning method, comprising:
sending a first driving signal via a first signal line of a first side of a touch panel when the touch panel is in a power-saving mode;
receiving a first sensing signal via a second signal line of the first side of the touch panel when sending the first driving signal; and
controlling the touch panel to execute an corresponding action according to whether the first sensing signal complies with a predetermined rule;
wherein the first sensing signal is related to an inductive capacitor between the first signal line and the second signal line.

2. The method of claim 1, wherein the first signal line is next to the second signal line or belongs to a signal line group including the second signal line.

3. The method of claim 2, wherein controlling the touch panel to execute the corresponding action according to whether the first sensing signal complies with the predetermined rule comprises:
sending a second driving signal via the second signal line if the first sensing signal does not comply with the predetermined rule;
receiving a second sensing signal via a third signal line of the first side of the touch panel when sending the second driving signal; and
executing a corresponding action according to whether the second sensing signal complies with the predetermined rule.

4. The method of claim 2, wherein controlling the touch panel to execute the corresponding action according to whether the first sensing signal complies with the predetermined rule comprises:
sending a second driving signal via a third signal line when the first sensing signal does not comply with the predetermined rule;
receiving a second sensing rule via a fourth signal line of the first side of the touch panel when sending the second driving signal; and
executing a corresponding action according to whether the second sensing signal complies with the predetermined rule;
wherein the third signal line is next to the fourth signal line or near the fourth signal line.

5. The method of claim 2, wherein controlling the touch panel to execute the corresponding action according to whether the first sensing signal complies with the predetermined rule comprises:
controlling the touch panel to enter an operational mode from the power-saving mode if the first sensing signal complies with the predetermined rule.

6. The method of claim 1, wherein controlling the touch panel to execute the corresponding action according to whether the first sensing signal complies with the predetermined rule comprises:
sending a second driving signal via the second signal line if the first sensing signal does not comply with the predetermined rule;
receiving a second sensing signal via a third signal line of the first side of the touch panel when sending the second driving signal; and
executing a corresponding action according to whether the second sensing signal complies with the predetermined rule.

7. The method of claim 1, wherein controlling the touch panel to execute the corresponding action according to whether the first sensing signal complies with the predetermined rule comprises:
sending a second driving signal via a third signal line when the first sensing signal does not comply with the predetermined rule;
receiving a second sensing rule via a fourth signal line of the first side of the touch panel when sending the second driving signal; and
executing a corresponding action according to whether the second sensing signal complies with the predetermined rule;
wherein the third signal line is next to the fourth signal line or near the fourth signal line.

8. The method of claim 1, wherein controlling the touch panel to execute the corresponding action according to whether the first sensing signal complies with the predetermined rule comprises:
controlling the touch panel to enter an operational mode from the power-saving mode if the first sensing signal complies with the predetermined rule.

9. A touch panel scanning method, comprising:
sending a set of driving signals via a first set of signal lines of a first side of a touch panel when the touch panel is in a power-saving mode;
receiving a set of sensing signals via a second set of signal lines of the first side of the touch panel when sending the set of driving signals; and
controlling the touch panel to execute an corresponding action according to whether the set of sensing signals complies with a predetermined rule;
wherein the set of sensing signals is related to a set of inductive capacitors between the first set of signal lines and the second set of signal lines.

10. The method of claim 9, wherein:
the first set of signal lines comprises a signal line, and
the second set of signal lines comprises a plurality of signal lines.

11. The method of claim 9, wherein:
the first set of signal lines comprises a plurality of signal lines, and
the second set of signal lines comprises a signal line.

12. The method of claim 9, wherein the first set of signal lines is next to the second set of signal lines or belongs to a signal line set group including the second set of signal lines.

13. The method of claim 9, wherein controlling the touch panel to execute the corresponding action according to whether the set of sensing signals complies with the predetermined rule comprises:
controlling the touch panel to enter an operational mode from the power-saving mode if the set of sensing signals complies with the predetermined rule.

14. The method of claim 13, where in controlling the touch panel to execute the corresponding action according to whether the set of sensing signals complies with the predetermined rule comprises:
controlling the touch panel to enter an operational mode from the power-saving mode if a variation of the set of inductive capacitors corresponding to the set of sensing signals is larger than a predetermined value.
